(19) United States
(12) Patent Application Publication
(10) Pub. No.: US 2007/0242965 A1
(43) Pub. Date: Oct. 18, 2007

(54) IMAGE FORMING APPARATUS, IMAGE FORMATION CONTROL METHOD, AND COMPUTER PROGRAM PRODUCT

(76) Inventor: Hidenori AKAMATSU, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/696,967

(22) Filed: Apr. 5, 2007

(30) Foreign Application Priority Data
Apr. 13, 2006 (JP) 2006-110968

(51) Int. Cl. G03G 15/00

(52) U.S. Cl. 399/49

(57) ABSTRACT

A test pattern for position adjustment is written on an intermediate transfer body in a sheet interval when a plurality of normal images are written continuously, using a start signal as a trigger. The test pattern is read and fed back by a sensor to adjust image formation control conditions. A normal image on the intermediate transfer body is transferred onto a paper medium supplied in a secondary transfer unit. However, the test pattern passes through the secondary transfer unit without the paper medium being supplied, thereby staining a transfer roller. Therefore, the secondary transfer unit and a transfer belt are separated from each other by a contacting/separating mechanism, while the test pattern written in the sheet interval passes through the secondary transfer unit.

### CROSS-REFERENCE TO RELATED APPLICATIONS

The present document incorporates by reference the entire contents of Japanese priority document, 2006-110968 filed in Japan on Apr. 13, 2006.

### BACKGROUND OF THE INVENTION

1. Field of the Invention

The present invention relates to an image forming apparatus such as a laser printer or a digital copying machine.

2. Description of the Related Art

As an apparatus that forms an image on an image carrier by a two-dimensional write scanning method, an electrophotographic image forming apparatus that writes an image on a photoconductor by optical beam scanning such as laser beams to form the image through secondary transfer between image carriers has been widely known in recent years.

In the method of the known apparatus, a photoconductor is beam-scanned by laser beams lighting-controlled by a line image signal periodically in a main scanning direction, and a surface to be scanned of the photoconductor is normally shifted in a sub-scanning direction orthogonal to the main scanning direction, to write a two-dimensional image on the photoconductor by the exposure scanning method. An electrostatic latent image formed on the photoconductor by exposure scanning is developed by a toner, and transferred onto recording paper directly or via an intermediate transfer body, and undergoes a fixing process, thereby finishing an image forming process.

When a color image is to be formed according to the process mentioned above, optical beam scanning relative to the photoconductor is performed for each color component, and a color image is formed through a synthesizing process. As this process, there have been conventionally known a method in which a single photoconductor is commonly used for respective component colors, and color synthesis is performed by a write process or a transfer process, and a so-called tandem method in which the photoconductor is prepared for the number of component colors, writing is performed for each color, and color synthesis is performed in the transfer process.

In the case of the color image, the color becomes different from its original color, or out-of-color registration occurs between the synthesized images of respective color components, unless density and a write position between respective color components are appropriately controlled. Particularly, in the tandem method, exposure scanning is respectively performed to the photoconductors of respective color components and color synthesis is performed in the transfer process. Consequently, there is a high possibility that out-of-color registration occurs between the synthesized images of respective color components. Therefore, misregistration occurring between color images is detected to adjust operation conditions according to the misregistration, so that an appropriate image output can be obtained.

Density and misregistration are detected as a deviation amount from a reference value, by actually operating the apparatus to form an adjustment pattern and measuring the formed pattern. The adjustment pattern also includes a pattern for managing process control and blade turn-up other than the density and misregistration.

A method of forming an adjustment pattern on an intermediate transfer body for a tandem method using an intermediate transfer body has been conventionally known (see Japanese Patent Application Laid-open No. 2004-264556).

The method of forming the adjustment pattern on the intermediate transfer body has a problem of staining of a transfer roller due to the adjustment pattern.

The adjustment pattern and a normal image formed on the intermediate transfer body are finally cleaned. However, a dedicated cleaning apparatus is not used for the adjustment pattern, and one cleaning apparatus is commonly used. Accordingly, the adjustment pattern, which does not need to be subjected to secondary transfer from the intermediate transfer body to a paper medium, passes through a secondary transfer unit.

Accordingly, it is adjusted such that the pattern formed at the time of adjustment is not transferred, different from the normal image. However, when the adjustment pattern passes through the secondary transfer unit, toner adheres on an opposite transfer roller, because the paper medium is not put between these, and hence there is a possibility of being stained. If the toner adheres on the transfer roller, the toner is transferred to the back of the paper medium at the time of transferring the normal image to be formed afterwards (hereinafter, “back transfer”).

It is considered as a selection condition as to which of the secondary transfer unit and a sensor that detects the adjustment pattern is put on an upstream side, for maintaining appropriate operations thereof, respectively. In an embodiment described later (see FIG. 1), the secondary transfer unit is provided immediately on a downstream side of the photoconductor drum array, and the sensor is provided thereafter.

To eliminate the back transfer, there is a method of cleaning the toner adhered on the transfer roller. However, this method can be hardly adopted, because it is accompanied by a cost increase.

There is a method using control of a bias of the transfer unit, as a countermeasure against the back transfer, other than cleaning. Positive bias is applied by the transfer unit in a normal-image forming step, to transfer the toner image onto the paper medium. In an adjusting step, a reverse bias is applied when the pattern passes so that the pattern is not transferred, thereby preventing the transfer roller from being stained due to the operation.

Further, other than the method of applying the reverse bias, a method using a mechanism that brings the transfer unit into contact with or away from the intermediate transfer body has been under study. According to this method, the transfer roller in a state with the paper medium being not supplied is prevented from being stained by the adjustment pattern on the intermediate transfer body, by releasing a contact between the intermediate transfer body and the transfer roller at the time of adjustment, thereby avoiding the back transfer. At the time of forming the normal image thereafter, the intermediate transfer body is brought into contact with the transfer roller to perform transfer of the image onto the paper medium. This method achieves an expected object by the contacting/separating operation relative to the transfer roller.

A conventional example of the contacting/separating mechanism of the transfer unit is disclosed in Japanese Patent Application Laid-open No. 2005-77939. In the example shown in Japanese Patent Application Laid-open No. 2005-77939, the contacting/separating mechanism is provided to avoid wear of the transfer member by separating the transfer member from the photoconductor at the time of adjusting rotation speed of the photoconductor, or detaching a photoconductor of a color not required for a monochrome operation. However, the contacting/separating mechanism does not avoid the back transfer.

In the case of using the method of using the contacting/separating mechanism relative to the transfer roller, when adjustment by pattern detection is performed while the normal image forming process is sequentially performed, the adjustment operation accompanied with the contacting/separating operation is performed in an interrupting manner, after one image forming operation has finished. Therefore, there is always the downtime of several seconds (about 5 seconds to 8 seconds), during which the normal image forming process cannot be performed.

FIG. 20 is a timing chart of a relationship between the normal image forming operation and the adjustment operation by detecting the adjustment pattern in the conventional technique.

As shown in FIG. 20, when image formation becomes possible, a central processing unit (CPU) that controls a printer engine generates a start signal. Because the configuration of a control system of the printer engine is basically identical to that of the embodiment of the present invention, explanations will be made with reference to FIGS. 2 and 3.

In the normal image forming operation, after a predetermined time has passed since generation of the start signal, a sub-scanning gate is asserted as shown in /sub-scanning gate signal_4, to input image data to a write controller for writing an image. In this example, the sub-scanning gate signal is one, and gate signals for other colors are omitted.

The CPU performs one image formation, and starts a series of adjustment operations such as formation of the adjustment pattern, pattern detection, and calculation of a correction value at a set timing, during a period shifting to the next image (hereinafter, as “sheet interval”). At the time of adjustment, the CPU measures preset time Ta by a timer at a timing when the formed pattern passes through the secondary transfer unit, and when the time is reached, the CPU operates the contacting/separating mechanism to separate the secondary transfer roller being in a contact state, and after the pattern has passed through the secondary transfer unit, operates the contacting/separating mechanism again to maintain the contact state of the secondary transfer roller.

The CPU is masked such that the CPU cannot generate the start signal for forming the normal image for a period from the start to the end of an adjusting event including the operation of the contacting/separating mechanism. Therefore, the CPU cannot start the next image forming process, which causes the downtime of about 5 to 8 seconds. In other words, because the start signal is generated after having confirmed the end of the adjusting event, an image forming job requested by a user is not processed, and the user has to wait for the time taken by adding the sheet interval and the downtime.

Further, when the method of preventing the back transfer by applying the reverse bias is adopted, adhesion of the toner to the transfer roller is prevented by the reverse bias. However, there is a possibility that the toner can fall due to the contact when the pattern passes through the secondary transfer unit, depending on the contact state between the intermediate transfer body and the transfer roller, thereby causing deterioration of the pattern.

When a part of the pattern (for example, an edge) is detected by a sensor, to detect a deviation by an edge signal, if the pattern is degraded, a normal detection value cannot be obtained, thereby decreasing detection accuracy.

### SUMMARY OF THE INVENTION

It is an object of the present invention to at least partially solve the problems in the conventional technology.

According to an aspect of the present invention, an image forming apparatus includes an image carrier configured to carry an image; an image write unit configured to write a normal image and an adjustment pattern on the image carrier; a primary transfer unit that transfers the normal image and the adjustment pattern carried by the image carrier onto an intermediate transfer body; a secondary transfer unit that transfers the image carried by the intermediate transfer body onto an image medium; a write controller that controls the image write unit to write the normal image and the adjustment pattern on the image carrier, and includes a pattern-write-period setting unit that sets a write-enabled period relative to the adjustment pattern, in a sheet interval generated between the write-enabled periods of respective images set when a plurality of normal images are continuously formed; an adjustment pattern detector that detects the adjustment pattern carried by the intermediate transfer body; a transfer suspending unit that suspends transfer of the normal image by the secondary transfer unit; and a transfer suspension controller that operates the transfer suspending unit at a timing when the pattern formed during the period set by the pattern-write-period setting unit passes through the secondary transfer unit.

According to another aspect of the present invention, an image formation control method includes writing a normal image and an adjustment pattern on an image carrier according to a periodic scanning method by controlling an image write unit; primarily transferring the normal image carried by the image carrier onto an intermediate transfer body, and secondarily transferring the image carried by the intermediate transfer body onto an image medium; primarily transferring the adjustment pattern carried by the image carrier onto the intermediate transfer body, and detecting the adjustment pattern carried on the intermediate transfer body by a detector; and feedback controlling an image-formation operation system according to a detection result of the adjustment pattern, wherein the writing includes setting a write-enabled period relative to the adjustment pattern during a sheet interval generated between the write-enabled periods of respective images, when a plurality of normal images are formed continuously, and the adjustment pattern is written during the set period, and the detecting includes suspending secondary transfer to be operated at the transferring relative to the adjustment pattern.

According to still another aspect of the present invention, a computer program product stores therein a computer program that causes a computer to realize the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic configuration diagram of a color image forming apparatus according to an embodiment of the present invention;

FIG. 2 is a block diagram of a configuration of an outline of an image formation control system in an image forming apparatus in FIG. 1;

FIG. 3 depicts an I/F between a CPU and a write-signal processing ASIC in detail;

FIGS. 4A and 4B are schematic diagrams for explaining a contacting/separating operation state by a contacting/separating mechanism in a secondary transfer apparatus, and depict relevant parts in FIG. 1;

FIGS. 5A and 5B are schematic diagrams for explaining the contacting/separating operation state according to a modified example of the contacting/separating mechanism in FIGS. 4A and 4B;

FIG. 6 depicts a configuration of relevant parts of a system that controls the contacting/separating operation by the contacting/separating mechanism;

FIG. 7 depicts a control flow in the contacting/separating operation by the contacting/separating mechanism;

FIG. 8 is a timing chart of a relationship between an image forming operation and an operation of the contacting/separating mechanism;

FIG. 9 depicts a configuration of relevant parts of a system that controls a bias of the secondary transfer apparatus;

FIG. 10 depicts a control flow of a transfer bias of the secondary transfer apparatus;

FIG. 11 is a timing chart of a relationship between the image forming operation and a transfer bias control operation;

FIGS. 12A and 12B are an example of a relationship between an adjustment pattern and a toner detection sensor;

FIGS. 13A and 13B are schematic diagrams for explaining respectively a relationship between sensors of a diffused light detection method (A) and a regular reflection detection method (B) and a position adjustment pattern;

FIGS. 14A and 14B respectively depict a pattern (A) used for position adjustment between black, which is a reference color, and other colors, and an output (B) of a sensor that has detected an overlapping state of patterns;

FIG. 15 depicts a control flow of misregistration correction;

FIGS. 16A and 16B depict a density adjustment pattern (A) and a creation state of the pattern;

FIG. 17 depicts a blade-turn-up preventing pattern in a created state;

FIGS. 18A and 18B respectively depict a relationship (A) between a pattern at the time of combining a position adjustment pattern and the density adjustment pattern, and a sensor output (B);

FIG. 19 depicts another combination of the position adjustment pattern and the density adjustment pattern and a relationship between the combined pattern and the sensor; and

FIG. 20 is a timing chart of a relationship between a normal image forming operation and an adjustment operation by detecting an adjustment pattern in a conventional technique.

### DETAILED DESCRIPTION OF THE PREFERRED EMBODIMENTS

Exemplary embodiments of the present invention are explained below.

An embodiment explained below is an example in which the present invention is applied to a so-called tandem electrographic color image forming apparatus that performs optical write with a laser diode (LD) onto a photoconductor drum as an image carrier provided for each component color according to a two-dimensional scanning method in horizontal and vertical directions, synthesizes imaged color images to a color image on a belt as an intermediate transfer body, and outputs the image to a recording medium such as transfer paper by secondary transfer.

However, not only this method but also a method using a single photoconductor for respective colors and a method of synthesizing a color image by a transfer process from the intermediate transfer body can be executed as in the present embodiment, by using an apparatus that uses secondary transfer. Further, the apparatus can be a monochrome type, so long as the adjustment method by pattern write according to the present invention can be applied thereto.

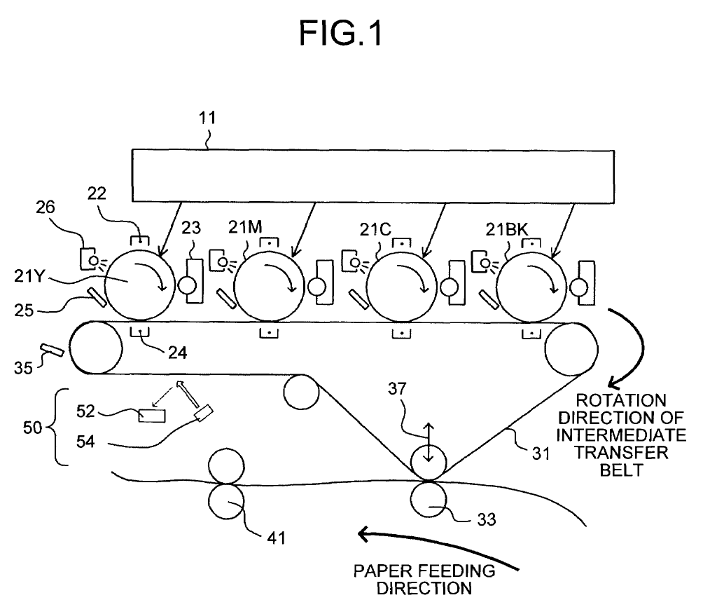

FIG. 1 is a schematic configuration diagram of a color image forming apparatus according to the present embodiment.

As shown in FIG. 1, as the photoconductor drum as the image carrier, drums 21Y, 21M, 21C, and 21Bk of four component colors, normally yellow (Y), magenta (M), cyan (C), and black (Bk), are arranged with a predetermined interval.

The photoconductor drums 21Y, 21M, 21C, and 21Bk of four component colors are subjected to write by LD beams respectively generated in an optical beam scanner 11 and imaging processing in an electrophotographic process to carry toner images of respective component colors formed on a drum surface.

Because write by the LD beams is performed according to the two-dimensional scanning method in horizontal and vertical directions, the optical beams are scanned in the main scanning direction (vertical direction in FIG. 1) by the optical beam scanner 11, and the photoconductor drums 21Y, 21M, 21C, and 21Bk are rotated in the sub-scanning direction, respectively, shown by arrow in FIG. 1.

In the embodiment shown in FIG. 1, the photoconductor drum is used as the image carrier on which the image is written, however, not only the drum but also a rotated endless photoconductor belt can be used as the image carrier (photoconductor).

A light source that emits the optical beams needs only to be able to modulate the output according to written image data, and a light emitting diode (LED) or electroluminescence (EL) can be used.

The color image forming apparatus includes a charger 22, a development apparatus 23, a primary transfer apparatus 24, a cleaning apparatus 25, and a discharger 26 required for imaging processing in the electrophotographic process, other than the optical beam scanner 11, around the respective color photoconductor drums 21Y, 21M, 21C, and 21Bk. Because imaging elements equipped around the respective color photoconductor drums are basically the same, except of color difference, Y of one component is explained.

In the imaging process performed by the elements mentioned above, the photoconductor drum 21Y is charged by the charger 22 to form an electrostatic latent image of an image to be formed according to write by irradiating the optical beams from the optical beam scanner 11. In the development apparatus 23, the toner is allowed to adhere on the created electrostatic latent image to form a visible image. Thereafter, the toner image to be fed due to rotation of the drum is transferred onto an intermediate transfer belt 31 as the intermediate transfer body by the primary transfer apparatus 24 and carried on the belt surface.

The toner remaining on the photoconductor drum 21Y is cleaned by a cleaning blade, a cleaning brush, or the like in the cleaning apparatus 25. The photoconductor surface of the drum after being cleaned is discharged by the operation of the discharger 26 to be prepared for the next imaging.

The intermediate transfer belt 31 is fed in a direction shown by arrow in FIG. 1 by an endless belt spanning across between a drive roller and a driven roller. The length of the belt needs to be a length along the four component-color drums 21Y, 21M, 21C, and 21Bk arranged with the predetermined interval, and when the drums are arranged in a linear array as shown in FIG. 1, the length of the belt becomes double. Accordingly, because a plurality of images can be carried on the belt with a sheet interval, print output by a continuous operation can be realized. In the example in FIG. 1, a secondary transfer apparatus 33 and a toner detection sensor 50 are provided in a path of the belt carried through a drum group and folded back.

The toner images created by the imaging process explained for one color, Y, relative to the images of respective colors are superposed (synthesized) on the intermediate transfer belt 31, and the synthesized toner image carried by belt movement is transferred onto a recording medium such as transfer paper by the secondary transfer apparatus 33. The recording medium such as transfer paper that carries the transferred toner image thereon is pressed by a roller heated to high temperature by a fuser 41, and fixed by thermo compression bonding, thereby finishing the image forming process.

In the tandem apparatus, images of respective component colors are superposed on the intermediate transfer belt 31 at the time of transfer of the image from the respective photoconductor drums 21Y, 21M, 21C, and 21Bk and color-synthesized.

Accordingly, an LD write timing to the respective photoconductor drums 21Y, 21M, 21C, and 21Bk by the optical beam scanner 11 is set so that a deviation does not occur between the images of respective component colors based on the arrangement of the respective drums and an apparatus condition of the optical beam scanner 11. Actually, however, misregistration occurs due to an influence of machine accuracy and a difference in an LD write system to the drum. Therefore, registration to adjust the write timing of images on the respective photoconductor drums is performed to correct and eliminate the deviation.

In deviation correction between the colors in the present embodiment, the image forming units for respective colors are actually operated to form a registration pattern on the intermediate transfer belt 31, misregistration occurring in the formed pattern due to a difference in characteristics of the respective color-image forming units is detected to correct the deviation based on the detection value. That is, in a case that image formation is performed in such a setting that when the apparatus operates as per a specification without error, registration patterns of respective colors are output in predetermined positions, a deviation from the predetermined position generated in the created pattern is detected as a deviation amount, and the detected deviation amount is fed back to a write unit to perform registration control.

Thus, in the tandem method, the deviation that likely occurs between the respective color images is adjusted by using the registration pattern. However, adjustment required for maintaining high quality in the image forming process includes density adjustment and an adjustment of a cleaning operation, other than the misregistration. Also for these adjustments, a method of forming the adjustment pattern is adopted, and the method is executed in the same manner as in the registration pattern. The adjustment pattern including these is in the scope of the present invention.

Because the deviation amount or an adjustment amount is obtained from a change in the adjustment pattern formed by operating an actual image forming unit, a unit that reads a change in the pattern is required. Therefore, as shown in FIG. 1, the toner detection sensor 50 is provided on the belt surface of the intermediate transfer belt 31.

The toner detection sensor 50 is an optical unit and formed of a light source 54 and a light receiving sensor 52. An example of various toner detection sensors used in the present embodiment is explained later.

A configuration of the image formation control system adjusted by an adjustment pattern detecting method is explained.

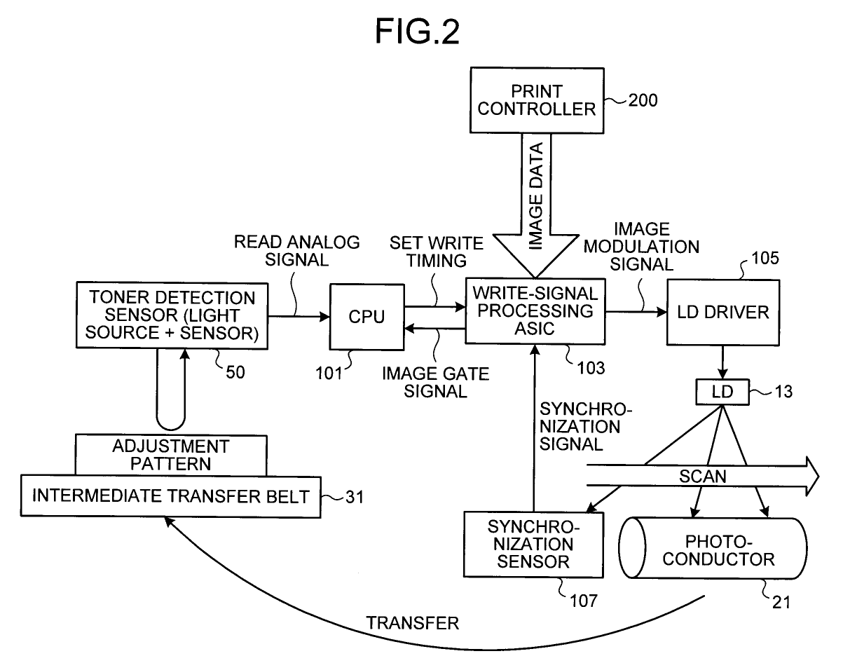

FIG. 2 is a block diagram of the configuration of the image formation control system. An example shown in FIG. 2 mainly depicts a configuration of an outline of the configuration when the adjustment pattern is for registration.

The image formation control system is formed of a CPU 101 that controls the entire apparatus, a write-signal processing application specific integrated circuit (ASIC) 103, an LD driver 105, an LD 13, a write unit having a synchronization sensor 107 and the like as an element, a print controller 200 that supplies the image data used for the write, and the toner detection sensor 50 that reads the adjustment pattern for adjusting the control condition of the write unit and other image forming units (not shown).

The CPU 101 sets a write timing in the write-signal processing ASIC 103, and issues a write trigger signal at the time of writing the normal image and the adjustment pattern on the photoconductor drum 21, respectively.

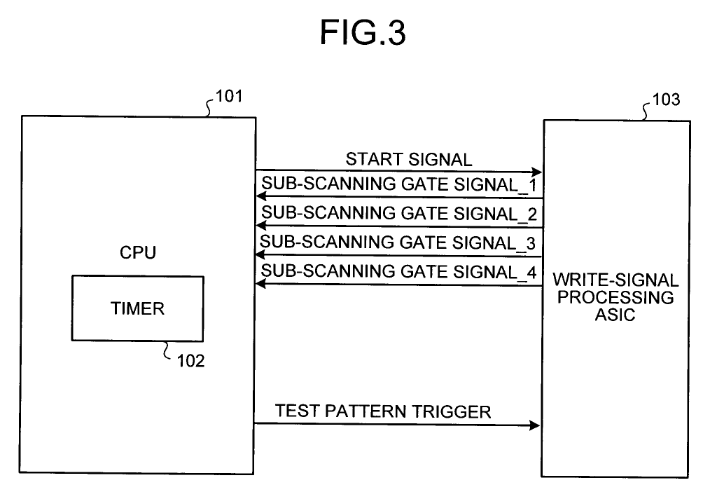

FIG. 3 depicts an interface (I/F) between the CPU 101 and the write-signal processing ASIC 103 in detail.

As shown in FIG. 3, the CPU 101 transmits a start signal as a trigger for instructing the write-signal processing ASIC 103 to start imaging of the normal image. The write-signal processing ASIC 103 having received the signal generates a sub-scanning gate signal for setting an imaging timing in the sub-scanning direction. The generated sub-scanning gate signal is used for setting a write area in the sub-scanning based on the signal as a reference, also transmitted to the CPU 101. At the time of a full color operation, as shown in FIG. 3, the sub-scanning gate signal is generated for prepared four colors.

The CPU 101 side receives the sub-scanning gate signal by a port and uses the signal as a signal for generating a drive timing of a paper transport motor and the like. The CPU 101 uses a built-in timer 102 for timing control.

The write-signal processing ASIC 103 has a pattern generator of the adjustment pattern as a test pattern, such as the registration pattern, process control, and a blade-turn-up preventing pattern built therein. The CPU 101 needs to transmit the trigger signal for the adjustment pattern to the write-signal processing ASIC 103 to write these adjustment patterns, as the start signal is transmitted in the normal image as the trigger.

The write-signal processing ASIC 103 converts the image data received from the print controller 200 at the time of forming the normal image or mark data held in the ASIC at the time of forming the adjustment pattern into an image modulation signal to transmit the image modulation signal to the LD driver 105. The LD driver 105 drives the LD 13 based on the modulation signal. The photoconductor drum 21 is exposure-scanned by the optical beams from the LD 13 light-controlled by the image data, thereby writing the image on the drum surface.

The synchronization sensor 107 in FIG. 2 generates a synchronization signal by detecting the beams at a home position on a scanning path of the scanning optical beams. The write-signal processing ASIC 103 writes the image at a constant timing based on the synchronization signal transmitted from the synchronization sensor 107 as a reference, thereby enabling to register respective main scanning line images.

The toner detection sensor 50 reads the adjustment pattern transferred onto the intermediate transfer belt 31 when the CPU 101 starts an operation for a test (adjustment) mode to write the adjustment pattern. The pattern is read in analog, and an obtained analog signal is fed back to the CPU 101.

The CPU 101 A/D converts the fed-back read analog signal and obtains data for adjusting the control condition of the write unit and other image forming units (not shown) based on the quantized read data. An optimum value of the control condition such as the write timing is obtained by the obtained adjustment data, and the value is reset as a control value for obtaining the high quality image having no misregistration and the like.

A processor that processes a signal such as a digital signal processor (DSP) can be provided at a previous stage of the CPU 101 for signal processing of the analog data output by the toner detection sensor 50.

A transfer suspending unit that suspends transfer is provided in the secondary transfer apparatus 33 that transfers the toner image on the intermediate transfer belt 31 onto the recording medium. The transfer suspending unit is indicated as a contacting/separating mechanism 37 in the embodiment shown in FIG. 1.

The adjustment pattern formed on the intermediate transfer belt 31 at the time of operating the test (adjustment) mode is for obtaining various adjustment data, and transfer to the recording medium such as the transfer paper is normally not required, so long as the toner detection sensor 50 reads the data. Particularly, when the normal images are printed out by a continuous operation, the test mode is operated in the sheet interval, and therefore the paper is not fed to the secondary transfer apparatus 33.

When the secondary transfer apparatus 33 is in a state with the transfer paper being not fed, if the secondary transfer apparatus 33 is maintained in a transfer state, the transfer roller in the secondary transfer apparatus 33 is stained when the intermediate transfer body carrying the adjustment pattern passes through the transfer unit. The stain causes the back transfer afterwards in the recording medium such as the transfer paper.

To prevent the back transfer, the transfer suspending unit is provided in the secondary transfer apparatus 33. The transfer suspending unit is operated to make the transfer inoperative when the adjustment pattern carried on the intermediate transfer body passes through the transfer unit, thereby preventing the secondary transfer apparatus 33 from being stained by the adjustment pattern image. On the other hand, when the normal image carried on the intermediate transfer body passes through the transfer unit, transfer is not suspended to enable secondary transfer onto the fed transfer paper.

An example adopting a method using a contacting/separating mechanism as the transfer suspending unit and an example adopting a method of controlling the transfer bias are separately explained as a “method using the contacting/separating mechanism” and a “transfer bias control method”.

### “Method Using Contacting/Separating Mechanism”

An example using the contacting/separating mechanism as the transfer suspending unit is shown in the configuration shown in FIG. 1. The contacting/separating mechanism 37 that brings the transfer roller on the intermediate transfer belt 31 side into contact with or away from an opposite roller in the secondary transfer apparatus 33 is shown in FIG. 1.

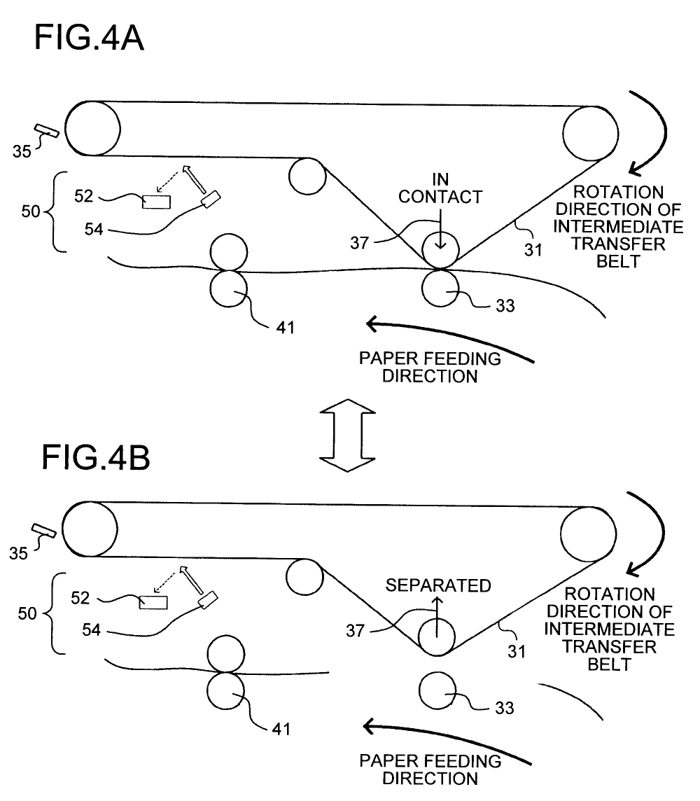

FIGS. 4A and 4B are schematic diagrams for explaining a contacting/separating operation state by the contacting/separating mechanism 37, and depicting relevant parts in FIG. 1.

FIG. 4A depicts a state where the contacting/separating mechanism 37 operates in a direction for bringing the opposite roller on the intermediate transfer belt 31 side into contact with the transfer roller. This state is maintained at least while the normal image carried on the intermediate transfer belt 31 passes through the secondary transfer apparatus 33 in a state with the transfer paper being fed.

On the other hand, FIG. 4B depicts a state where the contacting/separating mechanism 37 operates in a direction for bringing the opposite roller on the intermediate transfer belt 31 side away from the transfer roller. This state is maintained at least while the adjustment pattern image carried on the intermediate transfer belt 31 passes through the secondary transfer apparatus 33 in a state with the transfer paper being not fed.

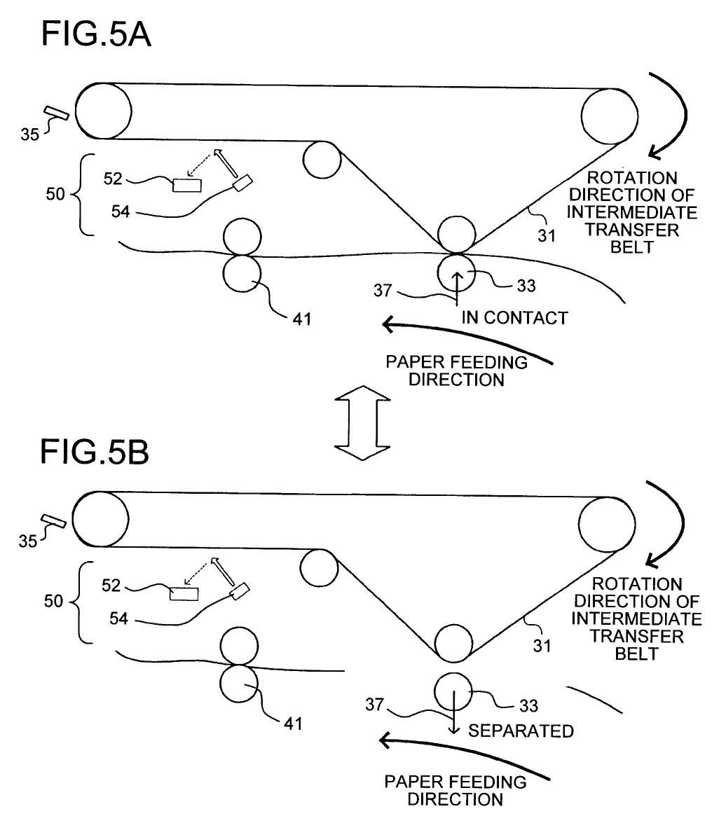

The method shown in FIGS. 4A and 4B in which the contacting/separating mechanism 37 is provided on the opposite roller on the intermediate transfer belt 31 side has an advantage in that the apparatus can be configured more easily than in a case that the contacting/separating mechanism 37 is provided on the secondary transfer apparatus 33 side shown in FIGS. 5A and 5B.

Further, this method can be executed by providing the contacting/separating mechanism 37 on the secondary transfer apparatus 33 side, instead of on the intermediate transfer belt 31 side.

FIGS. 5A and 5B are an example of the method in which the contacting/separating mechanism 37 is provided on the secondary transfer apparatus 33 side.

FIG. 5A depicts a state where the transfer roller comes in contact with the intermediate transfer belt 31. This state is maintained at least while the normal image carried on the intermediate transfer belt 31 passes through the secondary transfer apparatus 33 in the state with the transfer paper being fed.

On the other hand, FIG. 5B depicts a state where the transfer roller is separated from the intermediate transfer belt 31. This state is maintained at least while the adjustment pattern image carried on the intermediate transfer belt 31 passes through the secondary transfer apparatus 33 in the state with the transfer paper being not fed.

Since the intermediate transfer belt 31 side is fixed, the method in which the contacting/separating mechanism 37 is provided on the secondary transfer apparatus 33 side has an advantage in that the belt is stabilized and an influence on the image carried on the belt can be reduced, because a change occurring in the belt can be reduced than in the case of bringing the intermediate transfer belt 31 into contact with or away from the transfer roller.

The arrangement of the toner detection sensor 50 in FIG. 1 adopts a configuration using a characteristic in the case of using the contacting/separating mechanism method.

In the case of using the contacting/separating mechanism method, the intermediate transfer belt 31 and the transfer roller in the secondary transfer apparatus 33 are brought into contact with or away from each other by the contacting/separating mechanism 37, thereby maintaining the state of carrying the adjustment pattern image on the belt. Therefore, because the adjustment pattern image does not come in contact with the transfer roller, the roller can be reliably prevented from being stained due to the toner. In this respect, this method can be said to be a more reliable method than the transfer bias control method described later.

Therefore, when the contacting/separating mechanism having such a characteristic is adopted, read of the adjustment pattern image can be performed anywhere, regardless of the secondary transfer apparatus 33. Accordingly, design flexibility can be increased, because there is no restriction as in the transfer bias control method.

That is, the example shown in FIG. 1 selects a design in which the toner detection sensor 50 for reading the adjustment pattern is arranged on a downstream side of the secondary transfer apparatus 33 provided with the contacting/separating mechanism 37. In this case, the toner detection sensor 50 can be arranged on an upstream side of the secondary transfer apparatus 33. However, the arrangement shown in FIG. 1 can be selected when it is advantageous to provide the toner detection sensor 50 on the downstream side. Even in this arrangement, there is no difference in a read result of the sensor, and an error, which can occur in the transfer bias control method, does not occur.

When the contacting/separating operation for bringing the intermediate transfer belt 31 and the transfer roller in the secondary transfer apparatus 33 away from each other and returning these member into a contact state again is performed by the contacting/separating mechanism, a contacting/separating timing needs to be controlled.

To control the timing appropriately, the following points are taken into consideration in the present invention.

As a first point, the contacting/separating operation is performed matched with the timing when the adjustment pattern written in a period set as the write-enabled period in the sheet interval passes through the secondary transfer apparatus 33 provided with the contacting/separating mechanism 37.

It is because the period to write the adjustment pattern is set in the sheet interval, namely, in the write-enabled periods of the respective images set at the time of continuously forming a plurality of normal images, and therefore the contacting/separating operation needs to be performed at least corresponding to a toner image written in this period. In other words, while the toner image in an adjustment pattern write period is carried on the secondary transfer belt 31 and passes through the secondary transfer apparatus 33, the secondary transfer apparatus 33 in contact with the belt is separated from the belt, and after the toner image has passed through the secondary transfer apparatus 33, the secondary transfer apparatus 33 is brought into contact with the belt again for transferring the next normal image.

As another point, the timing for bringing the secondary transfer apparatus 33 into contact with or away from the intermediate transfer belt 31 is to be set so that an influence of a jitter, which occurs in the belt due to the contact or separation, on a formed image can be avoided.

In other words, the contacting/separating operation timing is set such that when the normal image and the adjustment pattern are carried on the intermediate transfer belt 31 and pass through the secondary transfer apparatus 33, transfer of the normal image can be completed without being affected by the jitter, which occurs in the belt at the time of separating the secondary transfer apparatus 33, the adjustment pattern reaches the secondary transfer apparatus 33 when the jitter is settled, and the jitter is settled at the time of bringing the secondary transfer apparatus 33 into contact with the intermediate transfer belt 31 after the adjustment pattern has passed through the secondary transfer apparatus 33 and before transfer of the next normal image is performed.

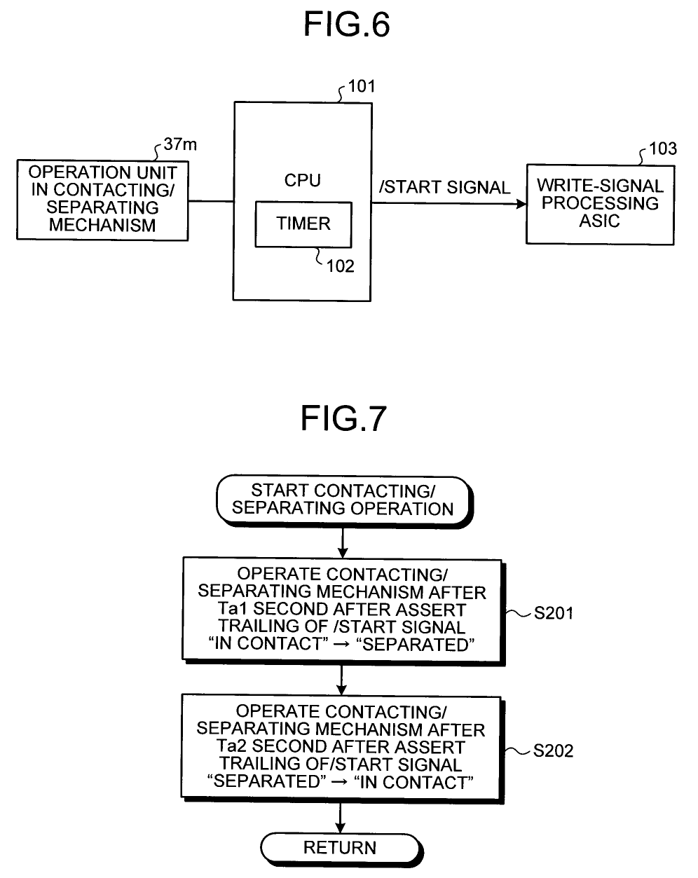

FIG. 6 depicts a configuration of relevant parts of a system that controls the contacting/separating operation of the contacting/separating mechanism 37. FIG. 6 is a schematic diagram of explaining a relationship between the CPU 101 that controls the entire apparatus and an operation unit 37m in the contacting/separating mechanism 37, and depicts relevant parts relating to the contacting/separating operation in the control system shown in FIG. 1.

As shown in FIG. 6, the CPU 101 generates the start signal as a trigger for instructing the write-signal processing ASIC 103 to start imaging of the normal image.

The start signal becomes a reference timing signal when the CPU 101 continuously writes the normal images to form the image, and writes the adjustment pattern in the sheet interval to control the operation for adjusting an image formation control condition in an integrated manner.

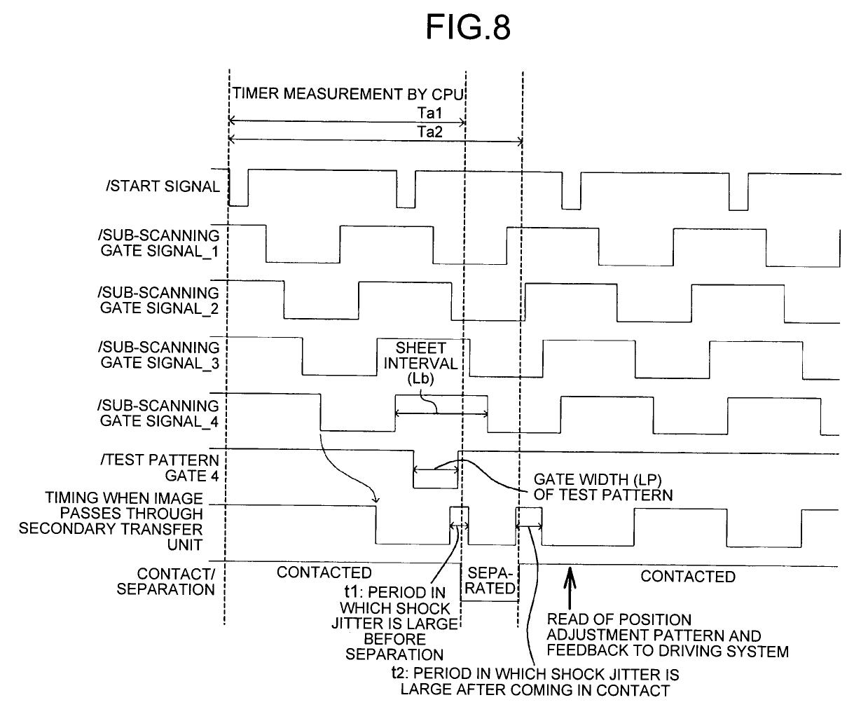

Accordingly, the CPU 101 operates the write-signal processing ASIC 103 based on the start signal, to set the timing for writing the adjustment pattern in the sheet interval, and set the timing for driving the operation unit 37m in the contacting/separating mechanism 37 so that the jitter and adhesion of the adjustment pattern to the secondary transfer apparatus 33 can be avoided (see timing chart shown in FIG. 8, which depicts a relationship between the write operation of the normal image and the adjustment pattern (test pattern) and the contacting/separating operation. As for these set values, a value experimentally calculated beforehand as an appropriate value is set, respectively.

FIG. 7 depicts a control flow in the contacting/separating operation by the contacting/separating mechanism 37.

The control flow shown in FIG. 7 is for operating the contacting/separating mechanism 37 according to the contacting/separating operation timing set in the above manner.

The CPU 101 starts the control flow in the contacting/separating operation by the contacting/separating mechanism 37, as a part of the control flow in which execution of adjustment using the adjustment pattern is instructed and an operation required for the adjustment is performed by a relevant device. At first, the CPU 101 asserts the start signal, and operates the contacting/separating mechanism 37 so that the intermediate transfer belt 31 and the secondary transfer apparatus 33 in contact with each other are separated at the time of measuring time Ta1 set by the timer 102 (step S201). The set time Ta1 is matched with the time when the adjustment pattern written in the sheet interval reaches the secondary transfer apparatus 33. However, the time is set, taking the jitter occurring in the belt into consideration, such that transfer of the normal image can be performed without being affected by the jitter, and the adjustment pattern arrives after the jitter has been settled.

The CPU 101 asserts the start signal and then operates the contacting/separating mechanism 37 so that the intermediate transfer belt 31 and the secondary transfer apparatus 33 in a state separated from each other are returned to the contact state when the timer 102 measures time Ta2 (step S202). The time Ta2 to be set is matched with the timing when the adjustment pattern in the sheet interval passes through the secondary transfer apparatus 33. However, the time is set such that the jitter is settled after the pattern has passed through and before transfer of the next normal image is performed, taking the jitter occurring on the belt into consideration.

An operation example of the contacting/separating mechanism 37 in the color image forming apparatus (see FIGS. 1 and 2) is explained with reference to a flowchart shown in FIG. 8.

In FIG. 8, the contacting/separating operation timing of the contacting/separating mechanism 37 performed matched with the timing when the normal image and the adjustment pattern pass through the secondary transfer unit is shown, in a case that an operation for continuously writing the normal images and writing the adjustment pattern in the sheet interval is performed.

The start signal shown in FIG. 8 is generated by the CPU 101 as a trigger for instructing the write-signal processing ASIC 103 to start imaging of the normal image (see FIGS. 3 and 6). The start signal is generated with a predetermined cycle for continuously writing the normal images. The timer 102 in the CPU 101 is started according to the start signal to determine the contacting/separating operation timing of the contacting/separating mechanism 37 after the time Ta1 and Ta2 have passed (see FIG. 7).

The sub-scanning gate signal is generated based on the start signal by the write-signal processing ASIC 103 and indicates the write-enabled period of the normal image.

Sub-scanning gate signals for four colors are used as /sub-scanning gate signal_1 to /sub-scanning gate signal_4 for controlling write on the photoconductor drum 21. Because an image is formed in the tandem method, as shown in FIG. 8, the sub-scanning gate signals for respective colors are generated with the write timing being shifted so that the respective color images can be synthesized by the primary transfer.

As shown by sub-scanning gate signal_4 in FIG. 8, a sheet interval (Lb) is generated in the write-enabled period between the current image and the next image in the sub-scanning gate signal. A test-pattern gate signal for writing the test pattern (adjustment pattern) is generated in the sheet interval.

There are two setting methods of the write-enabled period of the test pattern. One is a method of setting a period enabling write of a required pattern in one sheet interval so that the adjustment of the respective units in the apparatus performed according to a detection result of the written test pattern can be completed by the test pattern written in one sheet interval. The other is a method in which productivity of image formation is given priority, and the write-enabled period of the image is set so that a plurality of continuous normal images can be formed with a maximum capacity, and the test pattern is written in the sheet interval. According to the method of giving priority to the productivity, the adjustment may not be completed by the test pattern written in one sheet interval. Therefore, write of the necessary test pattern is performed over a plurality of sheet intervals.

The test-pattern gate signal indicating the write-enabled period (Lp) of the test pattern is restricted by the contacting/separating operation timing of the contacting/separating mechanism 37. In FIG. 8, only the test-pattern gate signal_4 is shown, using the sheet interval of the /sub-scanning gate signal_4 as an example, however, in the color image formation, the test-pattern gate signal is generated in the sheet intervals of four colors (three colors are not shown), and the pattern is written by the respective colors.

When the normal image and the test pattern are written in the write-enabled period set by the sub-scanning gate signal and the test-pattern gate signal, the written image is carried by the primarily transferred intermediate transfer belt 31 and reaches the secondary transfer apparatus 33 through the predetermined time.

The timing when the respective images of the normal image and the test pattern pass through the secondary transfer apparatus 33 is explained in FIG. 8. The respective color images of the normal image and the test pattern are synthesized by the primary transfer, and as shown by arrow in the drawing, after the time required for feeding of the belt has passed, reaches the secondary transfer apparatus 33.

At the contacting/separating operation timing of the contacting/separating mechanism 37, the contacting/separating mechanism 37 is separated from the intermediate transfer belt 31, matched with the time when the test pattern in the sheet interval passes through the secondary transfer apparatus 33. As explained above, the contacting/separating mechanism 37 is separated from the intermediate transfer belt 31 at the set time Ta1, and brought into contact with the intermediate transfer belt 31 at time Ta2, taking the jitter occurring in the belt into consideration. As shown in FIG. 7, for the contacting/separating operation, the time Ta1 is set so that transfer of the normal image can be performed without being affected by the jitter, and the test pattern arrives after the jitter has been settled. The time Ta2 is set so that the jitter is settled after the test pattern has passed through and before transfer of the next normal image is performed.

### “Transfer Bias Control Method”

The present embodiment realizes the transfer suspending unit by control of the transfer bias.

An example using the contacting/separating mechanism 37 as the transfer suspending unit is shown in the configuration shown in FIG. 1. However, an existing configuration can be used without newly providing the contacting/separating mechanism, by a method of controlling the secondary transfer apparatus 33.

The transfer suspending unit prevents the toner on the intermediate transfer belt 31 from moving at the time of transferring the toner image, by applying a reverse bias to the transfer bias of the secondary transfer apparatus 33 normally operated by a positive bias.

That is, because transfer is not performed onto a paper recording medium at the time of creating the adjustment pattern image, paper medium is not fed when the adjustment pattern passes through the secondary transfer apparatus 33. Therefore, the toner adheres on the transfer roller if the reverse bias is not applied. Accordingly, the toner adhesion can be prevented by applying the reverse bias.

Thus, the configuration of the image forming apparatus adopting the transfer bias control method is basically not different from the apparatus configuration in the method of using the contacting/separating mechanism 37, except that the contacting/separating mechanism is not required.

Control of the reverse bias can be easily executed according to a method described below, by directly using the existing hardware configuration, thereby obtaining actual effect of preventing the back transfer. Further, cost reduction can be realized, as compared to the method of using the contacting/separating mechanism 37.

In this method, toner adhesion to the transfer roller is prevented by applying the reverse bias. However, because there is no paper put between the intermediate transfer belt 31 and the transfer roller, there is a possibility that the toner on the adjustment pattern image can fall to degrade the pattern when the adjustment pattern passes through the secondary transfer apparatus 33, depending on the contact state.

The pattern degradation affects a pattern read result, and there can be a detection error in the read according to a diffused light method described later. Particularly, when a part of the pattern (for example, an edge) is detected by a sensor, to detect a deviation by an edge signal, if the pattern is degraded, a normal detection value cannot be obtained, thereby decreasing detection accuracy.

Therefore, a configuration for executing this method under an appropriate condition is shown below.

This configuration solves the above problem by selecting an arrangement of the toner detection sensor 50 so that even if degradation of the adjustment pattern occurs when the adjustment pattern passes through the secondary transfer apparatus 33, the degradation does not affect the detection by the toner detection sensor 50. That is, in the apparatus configuration using the contacting/separating mechanism 37 shown in FIG. 1, the toner detection sensor 50 can be arranged on the downstream side of the contacting/separating mechanism 37. However, in the case of using the transfer bias control method, the toner detection sensor 50 is arranged on the upstream side of the contacting/separating mechanism 37.

If the toner detection sensor 50 is arranged on the upstream side of the contacting/separating mechanism 37, the adjustment pattern is detected by the toner detection sensor 50, and then passes through the secondary transfer apparatus 33. Therefore, even if the adjustment pattern is degraded due to the transfer, the degradation does not affect the detection result, and therefore no error occurs. Accordingly, it is more appropriate to select this arrangement.

Positive/reverse control of the transfer bias of the secondary transfer apparatus 33 is performed to prevent transfer of the adjustment pattern. Therefore, the transfer bias is so controlled that the reverse bias is applied to the adjustment pattern, but the positive bias is applied to the normal image, which requires transfer.

To perform this operation, it is necessary to control the transfer bias so that the transfer bias is changed from the normal bias to the reverse bias at a timing when the adjustment pattern passes through the secondary transfer apparatus 33, and after the passage thereof, changed again to the normal bias.

In the transfer bias control method, when the transfer is suspended, the jitter that occurs due to a mechanical operation in the method of using the contacting/separating mechanism 37 does not occur. Therefore, the reverse-bias applying operation needs only to be performed, matched with the timing when the adjustment pattern written in a period set as the write-enabled period in the sheet interval passes through the secondary transfer apparatus 33. The reverse-bias applying operation cannot be performed exceeding the sheet interval. Therefore, after the sheet interval starts, the bias is changed from “normal” to “reverse”, and is changed again from “reverse” to “normal” before the sheet interval ends, thereby ensuring a normal transfer operation relative to the normal image.

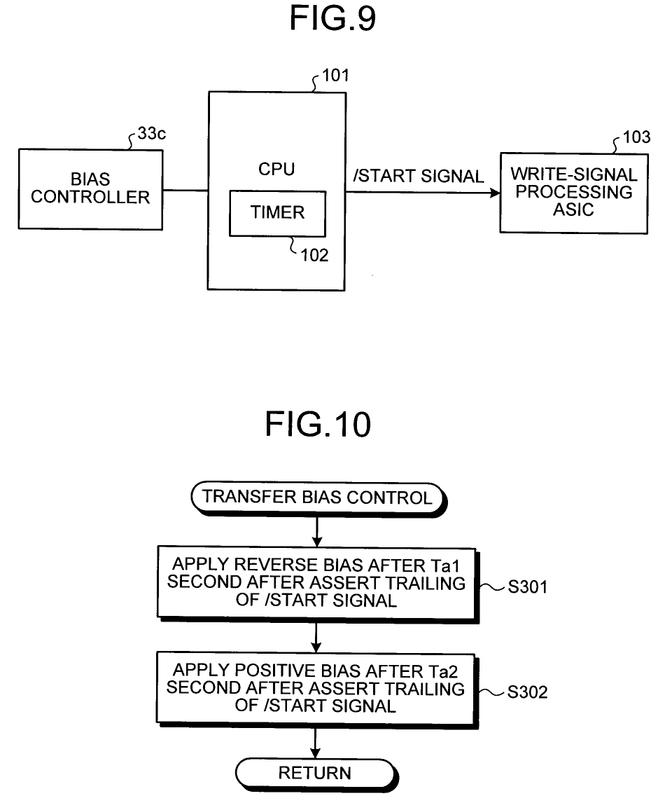

FIG. 9 depicts relevant parts of a system that controls the bias of the secondary transfer apparatus 33. FIG. 9 is a schematic diagram for explaining a relationship between the CPU 101 that controls the entire apparatus and a bias controller 33c that controls the bias in the secondary transfer, and depicts a configuration of relevant parts of a bias control operation in the control system shown in FIG. 1.

As shown in FIG. 9, the CPU 101 generates the start signal as a trigger for instructing the write-signal process ASIC 103 to start imaging of the normal image.

The start signal becomes a reference timing signal when the CPU 101 continuously writes the normal images to form the image, and writes the adjustment pattern in the sheet interval to control the operation for adjusting the image formation control condition in an integrated manner.

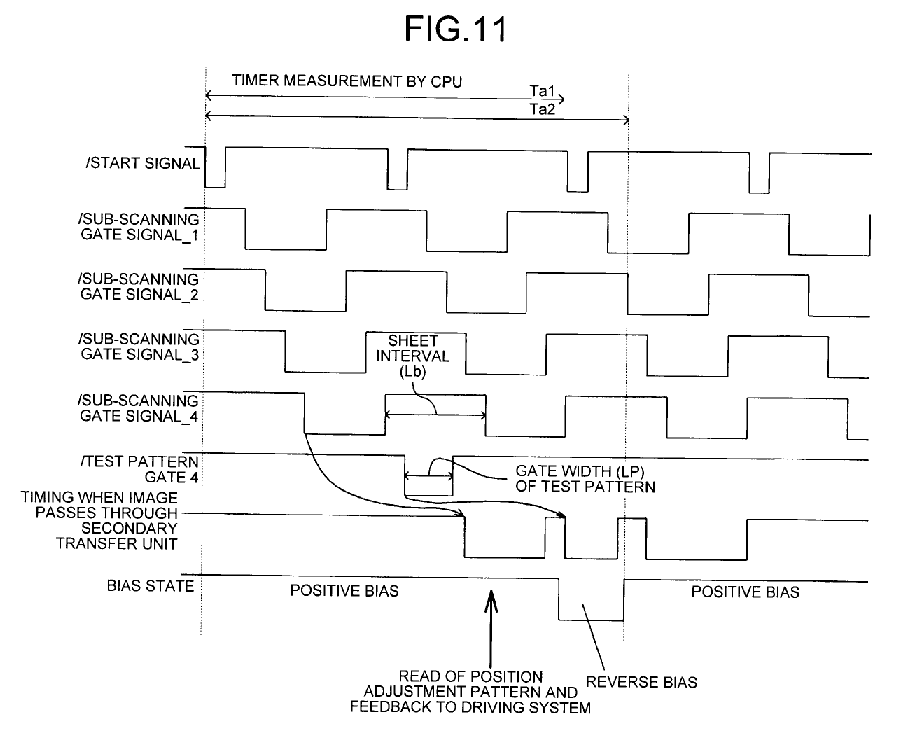

Accordingly, the CPU 101 operates the write-signal processing ASIC 103 based on the start signal, to set the timing for writing the adjustment pattern in the sheet interval, and set a control timing of “positive”X [symbol] “reverse” in the bias controller 33c that controls the transfer bias of the secondary transfer apparatus 33 so that adhesion of the adjustment pattern to the secondary transfer apparatus 33 can be avoided (see a timing chart shown in FIG. 11 indicating a relationship between the write operation of the normal image and the adjustment pattern (test pattern) and a bias state). As these set values, a value experimentally calculated beforehand as an appropriate value is set, respectively.

FIG. 10 depicts a control flow of the transfer bias of the secondary transfer apparatus 33.

The control flow in FIG. 10 is for operating the bias controller 33c according to the set transfer bias control timing.

The CPU 101 starts the control flow of the transfer bias, as a part of the control flow in which execution of adjustment using the adjustment pattern is instructed and an operation required for the adjustment is performed by a relevant device. At first, the CPU 101 asserts the start signal, and operates the bias controller 33c so that the reverse bias is applied to the secondary transfer apparatus 33, to which the positive bias has been applied, at the time of measuring time Ta1 set by the timer 102 (step S301). The set time Ta1 is matched with the time when the adjustment pattern written in the sheet interval reaches the secondary transfer apparatus 33. However, the time Ta1 can be set in the sheet interval immediately before the adjustment pattern arrives.

Further, the CPU 101 asserts the start signal and operates the bias controller 33c so that the positive bias is applied to the secondary transfer apparatus 33, to which the reverse bias has been applied, at the time of measuring the time Ta2 by the timer 102 (step S302). The time Ta2 can be set in the sheet interval immediately after the adjustment pattern has passed through the secondary transfer apparatus 33.

A control operation example of the transfer bias in the secondary transfer apparatus 33 in the color image forming apparatus according to the present embodiment is explained with reference to a timing chart shown in FIG. 11.

In FIG. 11, the control operation timing of the transfer bias performed matched with the timing when the normal image and the adjustment pattern pass through the secondary transfer unit is shown, in a case that an operation for continuously writing the normal images and writing the adjustment pattern in the sheet interval is performed.

As shown in FIG. 11, the start signal is generated by the CPU 101 as a trigger for instructing the write-signal processing ASIC 103 to start imaging of the normal image (see FIGS. 3 and 9). The start signal is generated with a predetermined cycle for continuously writing the normal images. The timer 102 in the CPU 101 is started according to the start signal to determine the control timing of the transfer bias in the secondary transfer apparatus 33 after the time Ta1 and Ta2 have passed (see FIG. 10).

The sub-scanning gate signal is generated based on the start signal by the write-signal processing ASIC 103 and indicates the write-enabled period of the normal image.

Sub-scanning gate signals for four colors are used as /sub-scanning gate signal_1 to /sub-scanning gate signal_4 for controlling write on the photoconductor drum 21. Because an image is formed in the tandem method, as shown in FIG. 11, the sub-scanning gate signals for respective colors are generated with the write timing being shifted so that the respective color images can be synthesized by the primary transfer.

As shown by sub-scanning gate signal_4 in FIG. 11, the sheet interval (Lb) is generated in the write-enabled period between the current image and the next image in the sub-scanning gate signal. A test-pattern gate signal for writing the test pattern (adjustment pattern) is generated in the sheet interval.

The test-pattern gate signal indicating the write-enabled period (Lp) of the test pattern is restricted by the control timing of the transfer bias in the secondary transfer apparatus 33. In FIG. 11, only the test-pattern gate signal_4 is shown, using the sheet interval of the /sub-scanning gate signal_4 as an example, however, in the color image formation, the test-pattern gate signal is generated in the sheet intervals of four colors (three colors are not shown), and the pattern is written by the respective colors.

When the normal image and the test pattern are written in the write-enabled period set by the sub-scanning gate signal and the test-pattern gate signal, the written image is carried by the primarily transferred intermediate transfer belt 31 and reaches the secondary transfer apparatus 33 through the predetermined time.

The timing when the respective images of the normal image and the test pattern pass through the secondary transfer apparatus 33 is explained in FIG. 11. The respective color images of the normal image and the test pattern are synthesized by the primary transfer, and as shown by arrow in the drawing, after the time required for feeding of the belt has passed, reaches the secondary transfer apparatus 33.

At the control timing of the transfer bias in the secondary transfer apparatus 33, the reverse bias is applied to the transfer bias, matched with the time when the test pattern in the sheet interval passes through the secondary transfer apparatus 33 to prevent movement of the toner. As explained above, the positive bias is changed to the reverse bias at the set time Ta1, and the reverse bias is changed to the positive bias again at time Ta2. As shown in FIG. 10, in the bias control operation, the time Ta1 is set so that the secondary transfer can be normally performed by applying the positive bias when the normal image passes through the secondary transfer apparatus 33, and adhesion of the toner to the transfer roller is prevented by applying the reverse bias when the test pattern passes through the secondary transfer apparatus 33. The time Ta2 is set so that the reverse bias is changed to the positive bias by which the normal image can be transferred after the test pattern has passes.

### “Detection of Adjustment Pattern”

An example according to an adjustment pattern detection method is described below.

In this method, the image forming apparatus is actually operated to form the adjustment pattern on the intermediate transfer belt. Because apparatus characteristics, apparatus condition, and the like are reflected on the formed adjustment pattern, this mark is read by an optical sensor to detect a change therein, so that the control condition relating to the image forming process is adjusted corresponding to the detection result, and appropriate image quality is maintained.

Variations of a mark pattern and the sensor as means corresponding to the control condition, to which the method can be applied, are explained below.

### “Position Adjustment of Image”

In the tandem image forming apparatus (see FIG. 1) according to the present embodiment, the image is respectively written on respective photoconductor drums 21Y, 21M, 21C, and 21Bk provided for each color component, and the images are synthesized on the intermediate transfer belt 31. Accordingly, misregistration can easily occur between the respective colors images, and therefore, position adjustment of respective color images is required, and a position adjustment pattern is detected.

The position adjustment pattern is written in the sheet interval as shown in the present embodiment (see FIGS. 8 and 11), and the mark pattern is read by the toner detection sensor 50 provided in the belt carrier path, after the respective color adjustment patterns are synthesized on the intermediate transfer belt 31.

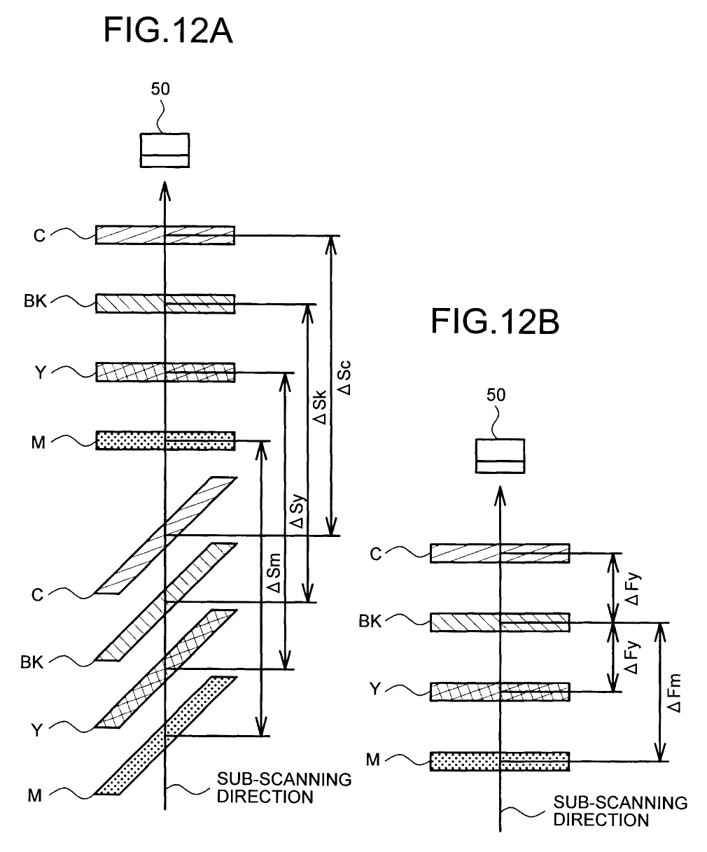

FIGS. 12A and 12B are an example of a relationship between the adjustment pattern and the toner detection sensor 50. FIG. 12A depicts a main-scanning deviation-amount detection pattern, and FIG. 12B depicts a sub-scanning deviation-amount detection pattern. These patterns are conventionally used, and are drawn using four colors.

These patterns are read by the toner detection sensor 50 to detect a main-scanning deviation amount and a sub-scanning deviation amount described below.

In the main scanning deviation by pattern A, a length between a horizontal line and an oblique line relative to the sub-scanning direction shown by arrow is calculated for each color as (ΔSc, ΔSk, ΔSy, and ΔSm). This length is obtained by measuring a line interval by the timer and converting it to a length.

In the sub-scanning deviation by pattern B, a line interval between horizontal lines relative to the sub-scanning direction shown by arrow is calculated as a length between a reference color (normally, block is used) and other colors (ΔFy, ΔFc, and ΔFm).

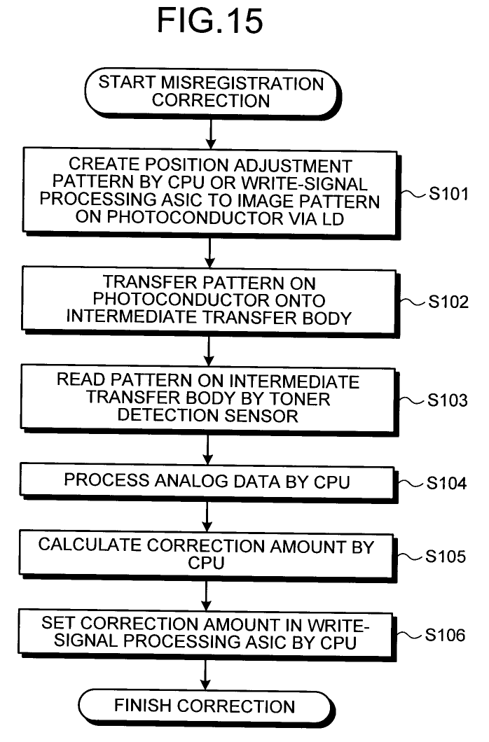

A misregistration amount from a target value (ideal value) is calculated for main and sub-scanning directions based on the obtained length and fed back to each device, to correct misregistration (a control flow of misregistration correction is shown in FIG. 15).

For the toner detection sensor 50 that reads the position adjustment pattern, a diffused light detection method or a regular reflection detection method can be used.

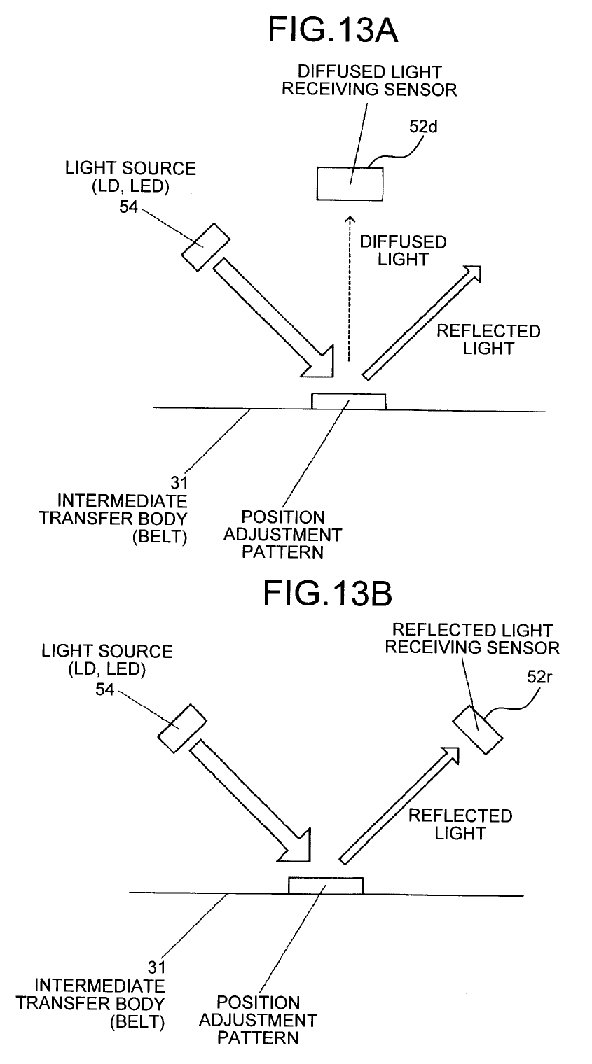

FIGS. 13A and 13B are schematic diagrams for explaining a relationship between sensors of these two methods and the position adjustment pattern.

The toner detection sensor 50 is formed of the light source 54 and light receiving sensors 52d and 54r. As the light source 54, LD or LED can be used. Because distribution of the reflected light amount is different according to the diffused light detection method or the regular reflection detection method, the light receiving sensors 52d and 52r change arrangement relationship with the light source and the configuration of the light receiving unit according to a light receiving method suitable for the distribution. Further, because the detection accuracy changes depending on different combinations of the light source and the sensor and characteristics of detection objects (the toner and a surface of the transfer body), optimum selection is performed, taking these into consideration.

When accuracy for detecting the pattern edge is required like the position adjustment pattern shown in FIGS. 12A and 12B, the regular reflection detection sensor is appropriate.

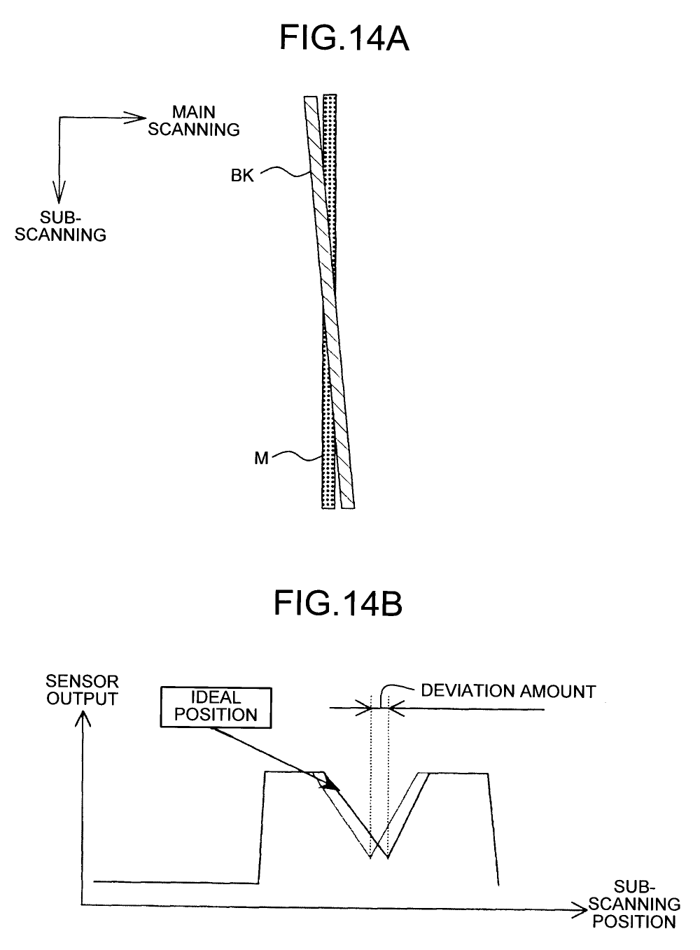

As a pattern suitable for using the diffused light detection sensor, a pattern shown in FIGS. 14A and 14B can be exemplified.

FIG. 14A depicts a pattern used for position adjustment between black as the reference color and other colors. In the pattern shown herein, overlap of black and other colors is shifted in the sub-scanning direction.

A sensor output when an overlapped degree of the patterns is detected in the sub-scanning direction by the toner detection sensor 50 is shown in FIG. 14B. As shown in the drawing, the reflected light decreases most at a position where black and other colors overlap on each other completely, and therefore a valley is generated in an output waveform. By detecting the sub-scanning position at a point of the valley, a deviation from the target value (ideal value) obtained beforehand is known, which can be detected as a misregistration amount in the main scanning direction.

### “Image Misregistration Correction”

The position adjustment pattern formed in the above manner is read by the toner detection sensor 50 and a detected amount is fed back to obtain a misregistration amount, and misregistration correction for adjusting such that the image does not have any misregistration is performed based on the misregistration amount. A series of an adjustment (correction) operation starting from creation of the mark is explained according to a control flow shown in FIG. 15.

Upon reception of an instruction to perform misregistration correction, the CPU 101 starts a control operation according to the flow shown in FIG. 15, and images a position adjustment pattern on the photoconductor drum 21 (step S101). Image data of the position adjustment pattern is created by the write-signal processing ASIC 103 or the CPU 101, and this image data is used to write a mark pattern on the photoconductor drum 21 and perform imaging. The timing is set such that write of the mark pattern is performed in the sheet interval of the continuously written normal images.

Subsequently, the mark pattern formed on the photoconductor drum 21 is primarily transferred onto the intermediate transfer belt 31 (step S102).

The mark pattern transferred onto the photoconductor drum 21 is read as an analog signal by the toner detection sensor 50 provided in the carrier path (step S103).

The analog signal read by the toner detection sensor 50 is fed back to the CPU 101, and the CPU 101 quantizes the received read analog signal by A/D conversion (step S104).

The CPU 101 then obtains position data from the fed back pattern read data to obtain a deviation amount from the target position, and calculates a correction amount of the write timing required for position adjustment (step S105). According to a pattern read example shown in FIG. 12B, an interval between Bk and C read by the toner detection sensor 50 is ΔFc. At this time, from a difference ΔC between the read ΔFc and ΔFc0, which is a target value of the interval, ΔC=ΔFc-ΔFc0, the number of lines and +/−direction can be calculated as a correction amount in the sub-scanning direction for negating the difference.

Thereafter, the obtained correction amount of the write timing is set in the write-signal processing ASIC 103 (step S106), to finish the correction control procedure.

### “Other Mark Patterns”

Other patterns, to which the mark pattern read method can be applied, include a density adjustment pattern used for a process control computer.

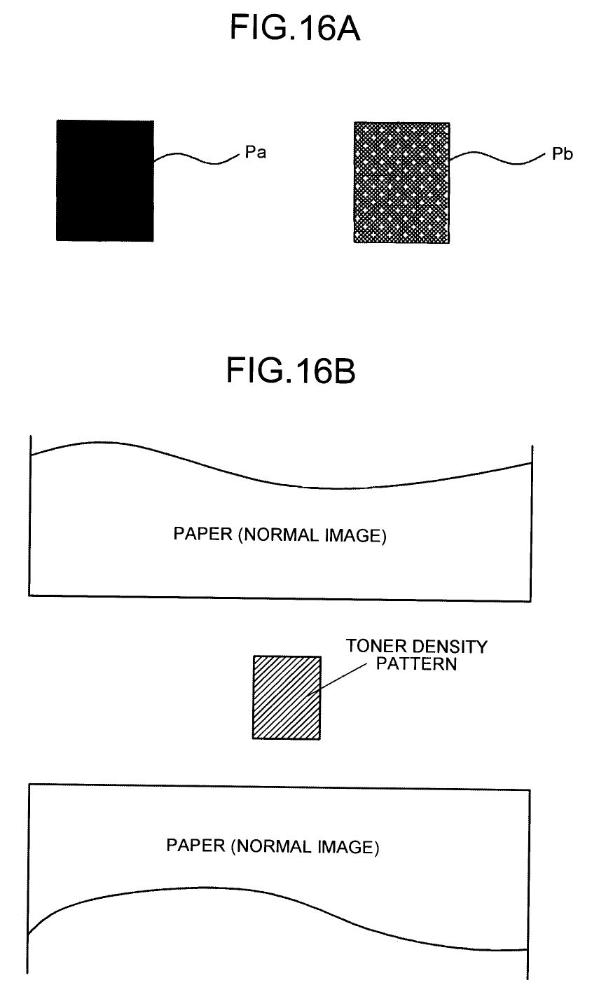

As this pattern, a solid pattern Pa or a halftone dot pattern Pb expressing density at the time of half tone by thinning dots by meshing as shown in FIG. 16A is formed as a toner patch. Such a pattern is formed in the sheet interval as shown in FIG. 16B, as in the position adjustment pattern, and read by the toner detection sensor 50. As the toner detection sensor 50, a regular reflection type and a diffused light type can be used.

The basic control operation is such that a density value is specified to form a toner patch, the toner patch is read by the sensor, obtained density data is compared with a reference value, and a density control condition is adjusted to be matched with the reference value, thereby feeding back the density control condition to image density.

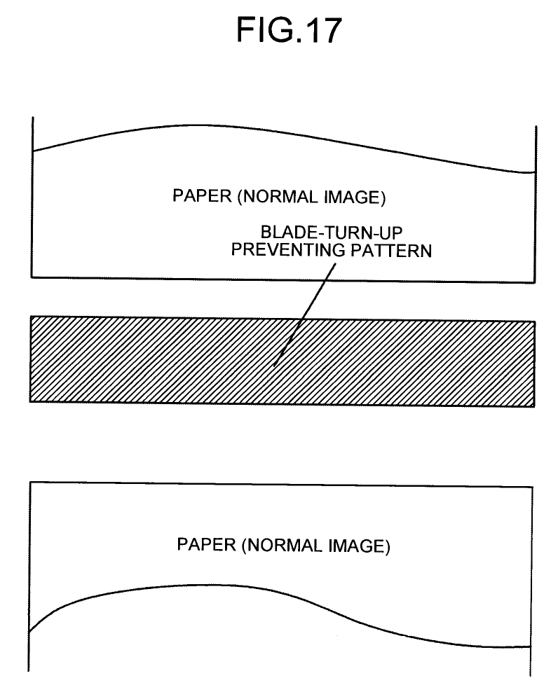

Further, the mark pattern read method can be applied by using a blade-turn-up preventing pattern shown in FIG. 17 as a pattern for the process control computer. The pattern is formed in the sheet interval, and after a blade in the cleaning apparatus has passed, the pattern is read. Cleaning performance is shown in a read result and the read result is compared with a reference value, thereby evaluating the performance.

### “Combination of Various Adjustment Patterns”

A read and control operation based on the read result can be performed at a high speed by forming a combination of the various patterns in the sheet interval and using a plurality of sensors to read the patterns at the same time.

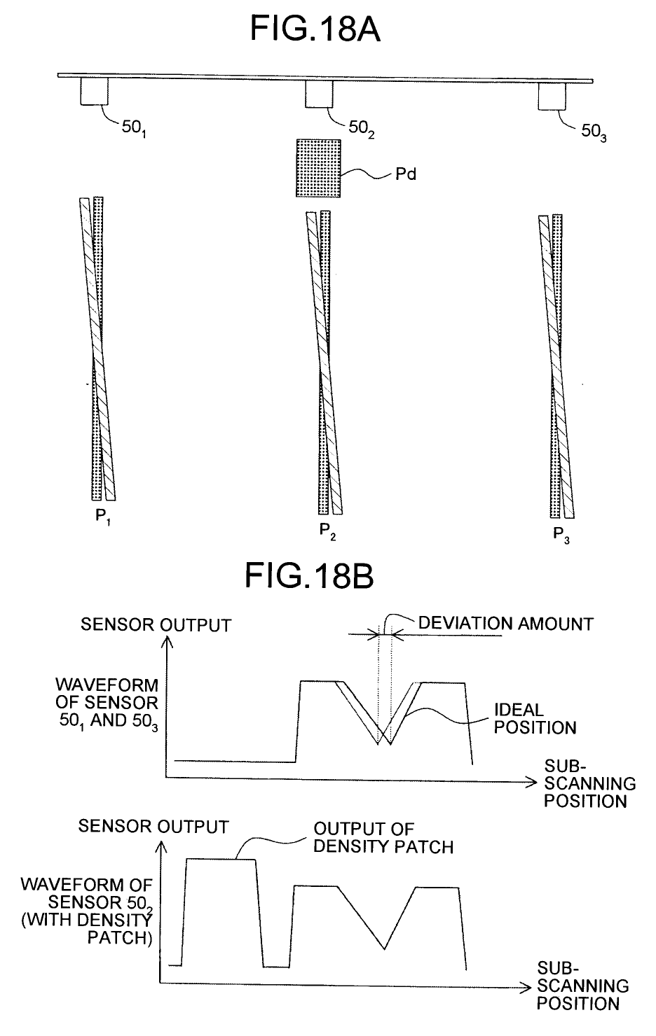

FIGS. 18A and 18B are an example in which the position adjustment pattern and the density adjustment pattern are combined.

In the example shown in FIGS. 18A and 18B, as shown in FIG. 18A, patterns P1, P2, and P3 for position adjustment similar to the one shown in FIGS. 14A and 14B are formed at three positions in the main scanning direction. Therefore, three sensors 50₁, 50₂, and 50₃ are provided corresponding to the position adjustment patterns P1, P2, and P3. A density adjustment pattern Pd is formed at a position where the sensor 50₂ can be commonly used.

According to a configuration in which the adjustment pattern and the sensor are associated with each other as shown in FIG. 18A, an output of the sensor that reads the pattern moving in the sub-scanning direction changes as shown in FIG. 18B.

That is, detection corresponding to a main scanning misregistration becomes possible from the sensor output of the sensors 50₁ and 50₃, by catching a position change at the valley generated in the output. On the other hand, a signal for density adjustment can be detected from the sensor output of the sensors 50₂ according to the output obtained by reading the density patch, and a position change at the valley is caught following the read of the density patch, thereby performing detection corresponding to the main scanning misregistration.

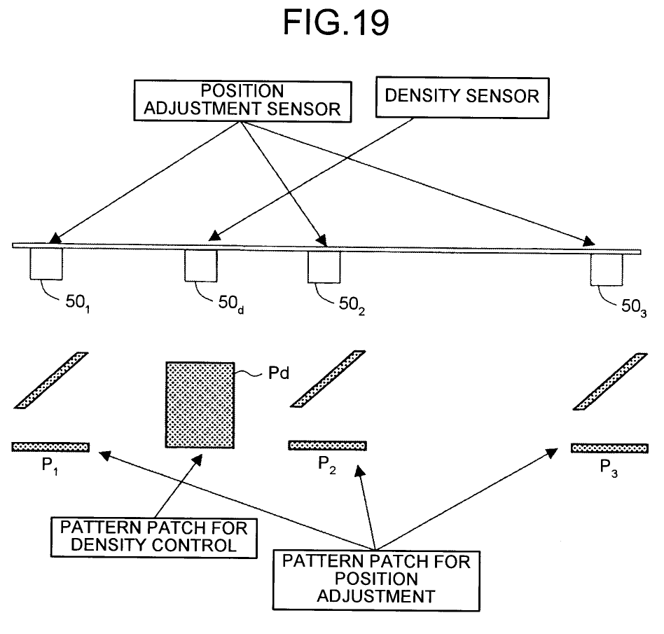

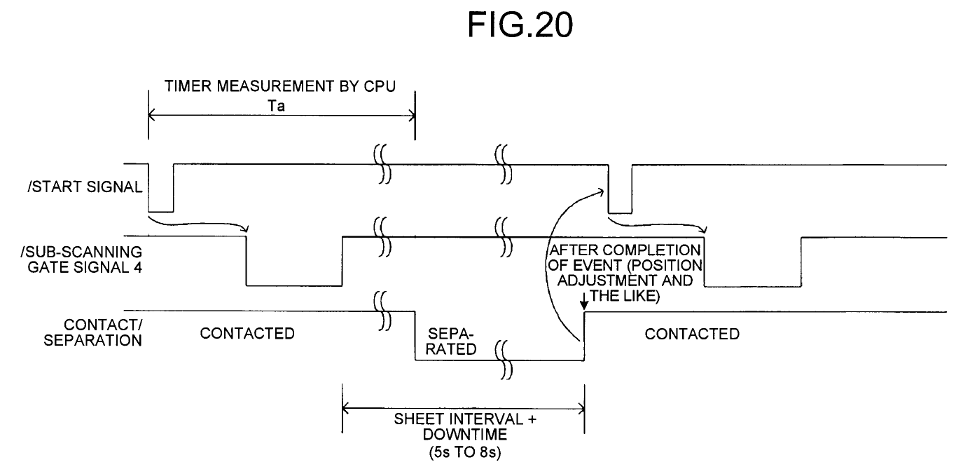

FIG. 19 is another example in which the position adjustment pattern and the density adjustment pattern are combined.

In this example, as shown in FIG. 19, position adjustment patterns P1, P2, and P3 similar to those shown in FIGS. 12A and 12B are formed at three positions in the main scanning direction. Therefore, three sensors 50₁, 50₂, and 50₃ are provided corresponding to the position adjustment patterns P1, P2, and P3. The density adjustment pattern Pd is also formed at a position where an independent sensor 50_{d} can read the density adjustment pattern Pd.

As shown in FIG. 19, by having such a configuration in which the density adjustment pattern Pd can be read by the independent sensor 50_{d}, a sensor exclusive for density can be used. Further, a pattern formation area can be made short in the sub-scanning direction, as compared to the example shown in FIGS. 18A and 18B.

### “Feedback of Adjustment Pattern Detection”

After the adjustment pattern is read and misregistration and density difference relative to a target value are detected from the read result, feedback control relative to relevant operation units is performed according to the detection result for adjusting the control condition relating to the image forming process.

It is desired that the feedback timing is basically at the time of detection on the real time basis. Therefore, control is performed at the time of detection relative to an operation unit, to which feedback is possible even during the operation, among operation units to be controlled.

In the timing charts shown in FIGS. 8 and 11, in which the relationship between the image forming operation and a secondary-transfer suspending operation in the present embodiment is shown, an operation according to the basic feedback timing is shown. That is, in FIG. 8, because the toner detection sensor 50 is provided on the downstream side of the secondary transfer apparatus 33, the feedback timing is a timing when read is performed by the sensor after the secondary transfer. In FIG. 11, because the toner detection sensor 50 is provided on the upstream side of the secondary transfer apparatus 33, the feedback is performed at a timing when read is performed by the sensor before the secondary transfer.

However, because the write-signal processing ASIC 103 that generates the write timing signal does not accept the feedback at the time of asserting the sub-scanning gate signal, feedback is performed at a timing in the sheet interval during which the sub-scanning gate signal is negated. In the example shown in FIG. 8, because the sub-scanning gate signal is negated at a timing when read is performed by the sensor, adjustment of the writing timing in the write-signal processing ASIC 103 can be performed on the real time basis.

Thus, by performing feedback on the real time basis at the time of pattern read, an operation for continuously forming normal images can be ensured without generating the downtime.

According to the present invention, the write-enabled period is set relative to the adjustment pattern, in the sheet interval when normal images are formed continuously, and the transfer suspending unit is operated at the timing when the adjustment pattern formed in the set period passes through the secondary transfer unit. Therefore, the downtime can be reduced as compared to the conventional technique in which the contacting/separating mechanism of the secondary transfer roller is used. Further, degradation of the adjustment pattern, which can occur in the transfer suspending method, in which the reverse bias is applied to the transfer bias, can be avoided, thereby enabling to hold the high detection accuracy.

Furthermore, the influence of shock jitter, which occurs at the time of bringing the secondary transfer unit into contact with or away from the intermediate transfer body, can be avoided. Therefore, the back transfer can be prevented more reliably.

Further, because the adjustment pattern detector can be provided on the downstream side of the secondary transfer unit, design flexibility increases.

Further, a program provides functions of controlling the adjustment pattern formation timing and the operation such as suspending transfer of the adjustment pattern when the adjustment pattern passes through the secondary transfer unit, detecting the pattern, and performing adjustment based on the detection result. Accordingly, function realizing means can be easily configured.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus comprising:
an image carrier configured to carry an image;
an image write unit configured to write a normal image and an adjustment pattern on the image carrier;
a primary transfer unit that transfers the normal image and the adjustment pattern carried by the image carrier onto an intermediate transfer body;
a secondary transfer unit that transfers the image carried by the intermediate transfer body onto an image medium;
a write controller that controls the image write unit to write the normal image and the adjustment pattern on the image carrier, and includes a pattern-write-period setting unit that sets a write-enabled period relative to the adjustment pattern, in a sheet interval generated between the write-enabled periods of respective images set when a plurality of normal images are continuously formed;
an adjustment pattern detector that detects the adjustment pattern carried by the intermediate transfer body;
a transfer suspending unit that suspends transfer of the normal image by the secondary transfer unit; and
a transfer suspension controller that operates the transfer suspending unit at a timing when the pattern formed during the period set by the pattern-write-period setting unit passes through the secondary transfer unit.

2. The image forming apparatus according to claim 1, wherein the transfer suspending unit allows two states of a transfer state and an inoperative state by bringing the intermediate transfer body and the secondary transfer unit into contact with or away from each other.

3. The image forming apparatus according to claim 2, wherein the transfer suspension controller sets a timing for operating the transfer suspending unit so that shock jitter occurring at the time of contact or separation by the transfer suspending unit does not affect the pattern on the intermediate transfer body.

4. The image forming apparatus according to claim 2, wherein the adjustment pattern detector is provided on a downstream side of the secondary transfer unit.

5. The image forming apparatus according to claim 1, wherein the image write unit is of a scanning exposure type, and performs writing of an image according to an electrophotographic process, and the transfer suspending unit operates a transfer bias in the secondary transfer unit in a reverse bias.

6. The image forming apparatus according to claim 5, wherein the adjustment pattern detector is provided on an upstream side of the secondary transfer unit.

7. The image forming apparatus according to claim 1, wherein the write controller sets the write-enabled period so that adjustment according to a detection result of the adjustment pattern detector can be completed during the sheet interval.

8. The image forming apparatus according to claim 1, wherein the write controller sets the write-enabled period relative to the adjustment pattern during the sheet interval generated by setting the write-enabled period, during which a plurality of continuous normal images can be formed with a maximum capacity.

9. The image forming apparatus according to claim 1, wherein the adjustment pattern is at least one pattern of a pattern for adjusting misregistration of a written image, a pattern for adjusting an imaging process including density, and a pattern for adjusting a cleaning member.

10. The image forming apparatus according to claim 9, wherein the image write unit combines a plurality of types of adjustment pattern to write the adjustment pattern during the write-enabled period relative to the adjustment pattern.

11. The image forming apparatus according to claim 1, further comprising a feedback controller that feedback-controls a relevant operation system according to the detection result of the adjustment pattern detector, wherein
the feedback controller performs an adjustment operation of the relevant operation system on a real time basis when the adjustment pattern is detected.

12. An image formation control method comprising:
writing a normal image and an adjustment pattern on an image carrier according to a periodic scanning method by controlling an image write unit;
primarily transferring the normal image carried by the image carrier onto an intermediate transfer body, and secondarily transferring the image carried by the intermediate transfer body onto an image medium;
primarily transferring the adjustment pattern carried by the image carrier onto the intermediate transfer body, and detecting the adjustment pattern carried on the intermediate transfer body by a detector; and
feedback controlling an image-formation operation system according to a detection result of the adjustment pattern, wherein
the writing includes setting a write-enabled period relative to the adjustment pattern during a sheet interval generated between the write-enabled periods of respective images, when a plurality of normal images are formed continuously, and the adjustment pattern is written during the set period, and
the detecting includes suspending secondary transfer to be operated at the transferring relative to the adjustment pattern.

13. The image formation control method according to claim 12, further comprising suspending that allows two-position state of a transfer state and an inoperative state by bringing the intermediate transfer body and the secondary transfer unit into contact with or away from each other, as a secondary-transfer suspending unit, wherein
the suspending includes operating the transfer suspending unit at a timing when the adjustment pattern passes through the secondary transfer unit.

14. The image formation control method according to claim 12, the periodic scanning method being forming an image according to an electrographic process, wherein
the suspending includes operating a transfer bias in a reverse bias, at the timing when the adjustment pattern passes through the secondary transfer unit.

15. The image formation control method according to claim 12, wherein the feedback controlling includes performing an adjustment operation of a relevant operation system on a real time basis when the adjustment pattern is detected.

16. A computer program product that stores therein a computer program that causes a computer to execute:
writing a normal image and an adjustment pattern on an image carrier according to a periodic scanning method by controlling an image write unit;
primarily transferring the normal image carried by the image carrier onto an intermediate transfer body, and secondarily transferring the image carried by the intermediate transfer body onto an image medium;
primarily transferring the adjustment pattern carried by the image carrier onto the intermediate transfer body, and detecting the adjustment pattern carried on the intermediate transfer body by a detector; and
feedback controlling an image-formation operation system according to a detection result of the adjustment pattern, wherein
the writing includes setting a write-enabled period relative to the adjustment pattern during a sheet interval generated between the write-enabled periods of respective images, when a plurality of normal images are formed continuously, and the adjustment pattern is written during the set period, and
the detecting includes suspending secondary transfer to be operated at the transferring relative to the adjustment pattern.
